(19) United States
(12) Patent Application Publication
(10) Pub. No.: US 2010/0150349 A1
(43) Pub. Date: Jun. 17, 2010

(54) METHOD AND SYSTEM FOR PERFORMING QUANTUM BIT COMMITMENT PROTOCOL

(75) Inventors: Jeong Woon CHOI, Daejeon-si (KR); Ku-Young CHANG, Daejeon-si (KR); Dowon HONG, Daejeon-si (KR); Dong Pyo CHI, Seoul (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-si (KR)

(21) Appl. No.: 12/612,235

(22) Filed: Nov. 4, 2009

(30) Foreign Application Priority Data
Dec. 12, 2008 (KR) 10-2008-0126822
Feb. 27, 2009 (KR) 10-2009-0016917

(51) Int. Cl. H04L 9/00

(52) U.S. Cl. 380/256

(57) ABSTRACT

A method and system for performing a quantum bit commitment protocol is provided. The method of performing a quantum bit commitment protocol to send bit information from a first party to a second party includes a pre-commit phase to randomly select and send, by the second party, a quantum state to the first party; a commit phase to perform, by the first party, a unitary transformation on the quantum state to combine the bit information with the quantum state and send the unitary-transformed quantum state to the second party; a hold phase to hold the unitary-transformed quantum state for a predetermined time period; and a reveal phase to provide, by the first party, information about the unitary transformation to the second party to open the bit information to the second party. The reveal phase may include a verification process to check if the opened bit information matches the bit information committed in the commit phase. For example, the verification process may be performed by checking if a quantum state obtained by performing an inverse unitary transformation of the unitary-transformed quantum state matches the quantum state selected in the pre-commit phase.

### CROSS-REFERENCE TO RELATED APPLICATIONS

This application claims the benefit under 35 U.S.C. §119(a) of Korean Patent Application Nos. 10-2008-0126822, filed on Dec. 12, 2008, and 10-2009-0016917, filed on Feb. 27, 2009, the disclosures of which are incorporated by reference in their entirety for all purposes.

### BACKGROUND

1. Field

The following description relates to a bit commitment protocol and, more particularly, to a method and system for performing a quantum bit commitment protocol.

2. Description of the Related Art

In an information society, information has to be protected from an unauthorized access and an unauthorized modification. In computer or Internet environments, fundamental security technologies for secure information protection are called cryptographic primitives one of which is bit commitment protocol. Bit commitment protocol is applied to a variety of cryptographic protocols including secure coin flipping, zero-knowledge proofs, oblivious transfer, verifiable secret sharing, and multi-party secure computation.

Bit commitment protocol needs to have a concealing property and a binding property. The concealing property means that a committed bit cannot be known by a receiver; the binding property means that a sender cannot change the committed bit.

The binding and concealing properties may be implemented as follows: for example, Alice locks bit information in the safe and sends the safe to Bob while keeping the key. To reveal the information, Alice simply sends the key to Bob who opens the safe and reads the bit information. Alice and Bob refer to two mistrusting parties who are supposed to provide bit information. In this case, Bob cannot know the information in the safe as long as he does not break the safe (the concealing property); Alice cannot change the information in the safe after the safe was sent to Bob (the binding property).

In a classical cryptography, a one-way function, a pseudo-random number generator, or a discrete logarithm problem acts as the safe. However, means in the classical cryptography cannot ensure an absolute security for saved information. The classical cryptography guarantees a relative security based on a computational complexity depending on the time consumed in finding a solution to a given problem.

To address the relative security in the classical cryptography and ensure an unconditional or absolute security, quantum bit commitment protocol has been proposed. Similar to quantum key distribution (QKD) protocol, the quantum bit commitment protocol uses special properties in quantum mechanics, such as the Heisenberg uncertainty principle or quantum entanglement. A number of researches have been conducted to ensure an unconditional security using such properties in quantum mechanics.

Unlike the quantum key distribution protocol, however, the quantum bit commitment protocol has been highly controversial in a security issue. In particular, EPR (Einstein-Podolsky-Rosen) paradox has challenged a feasibility of the quantum bit commitment protocol. In the late 1990's, the Mayers-Lo-Chau (MLC) no-go theorem proved that the quantum bit commitment protocol is infeasible under a generalized situation. According to the MLC theorem, if the protocol is unconditionally concealing, then Alice can make an EPR attack against the committed bit information, effectively defeating the binding property, while keeping the deceptive act hidden from Bob.

It shows that singular properties of quantum mechanics may have a limited effect on the security of cryptography and may not play a role in cryptography more than classical mechanics. After the presentation of the MLC theorem, however, questions began to arise on whether the MLC theorem could be applied to all possible protocol systems. In the meantime, great efforts have been made to develop new types of protocols to implement the quantum bit commitment.

Meanwhile, Kent proposed a quantum bit commitment protocol using the special theory of relativity in 1999. Kent introduced an unconditionally secure protocol by determining distances between users taking into account the times consumed in communications.

More specifically, there are a group of senders and a group of receivers who have their own priorities and perform bit commitment protocol according to priority. In this case, current bit information committed in order of the priority is already determined depending on previous bit information committed in a previous order. Furthermore, members in the same group are placed to be more spatially separated from each other than from their counterparts in the other group so that communications between members in the same group may have no effect on the following bit commitment. Accordingly, the receiver group cannot acquire the bit information by mutual consultation and the sender group cannot change the bit information by mutual consultation. Accordingly, this can solve the binding problem raised by the MLC theorem.

Such a scheme using the special theory of relativity which considers the time consumed in communications is called ‘a relativistic scheme’; otherwise, it is called a ‘non-relativistic scheme’. However, the relativistic bit commitment protocol according to Kent needs a too great amount of communications and has to secure distances between members in proportion to the communication time consumed. This leads to a limited holding time in a hold phase due to spatial constraints. In other words, a protocol requiring a longer holding time in the hold phase is not appropriate for the relativistic bit commitment according to Kent.

Accordingly, a non-relativistic bit commitment scheme which complies with the MLC theorem has been required. For one example, a pre-commit phase has been added in which a quantum state for bit commitment is randomly picked by a receiver instead of by a sender so that the sender may not make an EPR attack. However, this ensures the binding property but not the concealing property.

To address this problem, Yuen has proposed in 2000 a new protocol which employs a method of adding a great amount of bait conditions and performing a permutation. However, Yuen's protocol offers an asymptotic security rather than a complete security since the complete security requires an infinite amount of bait conditions.

### SUMMARY

The following description relates to a method and system for performing an unconditionally secure quantum bit commitment protocol using fundamental properties based on quantum mechanics such as the Heisenberg uncertainty principle and two-way quantum communications.

The following description also relates to a method and system for performing a quantum bit commitment protocol which is free from temporal and spatial restrictions caused by the application of the special theory of relativity and does not extra requirements such as a mediator or a bait condition.

In one general aspect, a method of performing a quantum bit commitment protocol to send bit information from a first party to a second party includes: a pre-commit phase to randomly select and send, by the second party, a quantum state to the first party; a commit phase to perform, by the first party, a unitary transformation on the quantum state to combine the bit information with the quantum state and send the unitary-transformed quantum state to the second party; a hold phase to hold the unitary-transformed quantum state for a predetermined time period; and a reveal phase to provide, by the first party, information about the unitary transformation to the second party to open the bit information to the second party.

The reveal phase may include a verification process to check if the opened bit information matches the bit information committed in the commit phase. The verification process may include checking if a quantum state obtained by performing an inverse unitary transformation of the unitary-transformed quantum state matches the quantum state selected in the pre-commit phase.

In another general aspect, a method of performing a quantum bit commitment protocol includes: randomly selecting, by a first party, a quantum state and sending the quantum state to a second party; and performing, by the second party, a unitary transformation on the received quantum state based on the bit information to be committed and sending the unitary-transformed quantum state to the first party.

The first party may hold the unitary-transformed quantum state for a predetermined time period, and the second party may reveal information about the quantum bit to the first party. Revealing the information about the quantum bit may include a verification process to send, by the second party, information about the unitary transformation to the first party and verify, by the first party, a binding property on the quantum bit using the information about the unitary transformation.

However, other features and aspects will be apparent from the following description, the drawings, and the claims.

### BRIEF DESCRIPTION OF THE DRAWINGS

FIG. 1 is a flow chart illustrating an exemplary method of performing a quantum bit commitment protocol.

FIG. 2 is a block diagram illustrating an exemplary system for performing a quantum bit commitment protocol.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

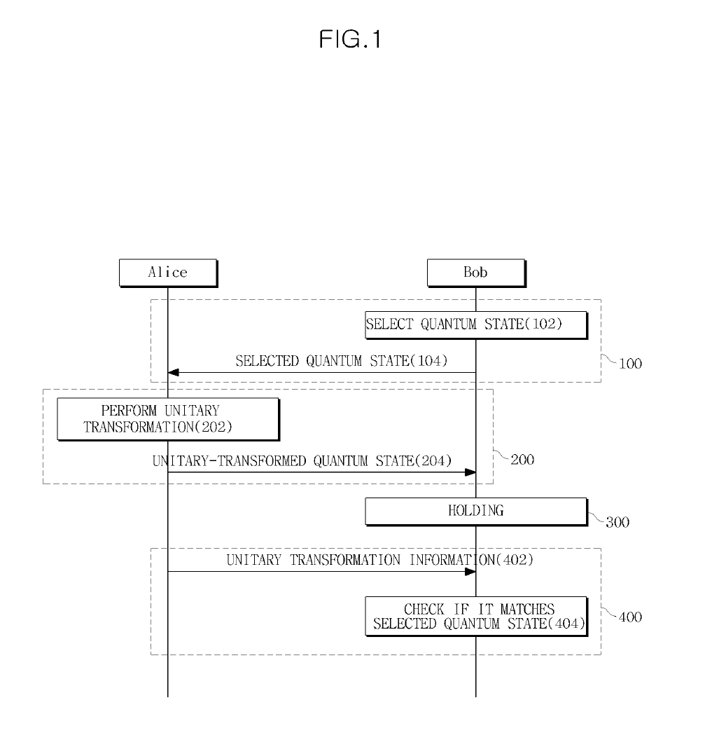

FIG. 1 is a flow chart illustrating an exemplary method of performing a quantum bit commitment protocol. In the current example, Alice refers to a committing party or sender who makes a quantum bit commitment, while Bob refers to a committed party or receiver of the quantum bit commitment. Alice and Bob may be spatially separated and may not trust each other. However, the current example is not limited thereto but may be applied to all parties for the quantum bit commitment. In addition, Alice and Bob may communicate information with each other in a two-way quantum communication as well as over a classical communication channel.

Referring to FIG. 1, the exemplary method of performing quantum bit commitment protocol includes a pre-commit phase (operation 100), a commit phase (operation 200), a hold phase (operation 300), and a reveal phase (operation 400).

In the pre-commit phase (operation 100), a receiver prepares a quantum state to contain bit information to be committed or to be associated with bit information. If the receiver prepares a photon with a predetermined quantum state or a certain polarization, a binding property may be ensured, which is one of properties essential in the quantum bit commitment protocol. In this phase (operation 100), to ensure anonymity of the quantum state, a non-orthogonal quantum state may be used with the same probability. However, a different quantum state with the same effect may be used or the non-orthogonal quantum state may be used with a certain probability.

For example, in the pre-commit phase (operation 100), Bob, the receiver, may use non-orthogonal quantum states, i.e., |0 [symbol] , |1 [symbol] , and

$$\vert + 〉 = \frac{\vert 0 〉 + \vert 1 〉}{\sqrt{2}} , \\ \vert - 〉 = \frac{\vert 0 〉 - \vert 1 〉}{\sqrt{2}} ,$$

with the same probability. Alternatively, Bob may randomly pick any one of the four states (operation 102). Bob sends the selected quantum state, |ν [symbol] , to Alice (operation 104). The quantum state, |ν [symbol] , (i.e., a photon with a predetermined polarization) may, without limitation, be sent over an optical communication channel, such as an fiber-optic cable or a free space.

The quantum state, |ν [symbol] , is sent to Alice while it is kept hidden. Since Bob randomly picks a quantum state and sends the quantum state to Alice while keeping it hidden, Alice appears to be given a maximum mixed state, ½1. That is, Alice cannot know the polarization of the photon which has been sent to her.

After receiving the quantum state, Alice commits bit information to Bob (operation 200). The bit information is not changed and bound to be kept secret between Alice and Bob for a predetermined time period. The bit information may be, but not limited to, a combination of ‘0’ and ‘1’.

To ensure a binding property and a concealing property, a set of non-orthogonal unitary transformations may be used for the bit commitment. More specifically, Alice performs a unitary transformation or unitary operation on the quantum state received from the Bob to input bit information (operation 202). That is, Alice combines the bit information to be committed with information on the received quantum state. Alice sends Bob the unitary-transformed quantum state, which includes or is combined with the bit information to be committed (operation 204). The information may, without limitation, be sent over a predetermined optical communication medium, such as a fiber-optic cable or a free space.

To input the bit information in operation 202, Alice may select one of sets of unitary transformations, {σₓ, σ_{z}} and {H, T}, depending on bits to be committed, and randomly use one of unitary transformations belonging to the selected unitary transformation set. Examples of the unitary transformations include

$${σ}_{x} = ( \begin{matrix}0 & 1 \\ 1 & 0\end{matrix} ) , \\ {σ}_{z} = ( \begin{matrix}1 & 0 \\ 0 & - 1\end{matrix} ) , \\ H = \frac{{σ}_{x} + {σ}_{z}}{\sqrt{2}} = \frac{1}{\sqrt{2}} ( \begin{matrix}1 & 1 \\ 1 & - 1\end{matrix} ) , \\ and$$

$$T = \frac{{σ}_{x} + {σ}_{z}}{\sqrt{2}} = \frac{1}{\sqrt{2}} ( \begin{matrix}- 1 & 1 \\ 1 & 1\end{matrix} ) .$$

For example, to commit ‘0’, Alice may randomly pick one of Pauli's unitary transformations,

$${σ}_{x} = ( \begin{matrix}0 & 1 \\ 1 & 0\end{matrix} )$$

$$and$$

$${σ}_{z} = ( \begin{matrix}1 & 0 \\ 0 & - 1\end{matrix} ) ,$$

to perform the unitary transformation. To commit ‘1’, Alice may randomly pick one of the linear combinations of Pauli's unitary transformations,

$$H = \frac{{σ}_{x} + {σ}_{z}}{\sqrt{2}} = \frac{1}{\sqrt{2}} ( \begin{matrix}1 & 1 \\ 1 & - 1\end{matrix} )$$

$$and$$

$$T = \frac{{σ}_{x} - {σ}_{z}}{\sqrt{2}} = \frac{1}{\sqrt{2}} ( \begin{matrix}- 1 & 1 \\ 1 & 1\end{matrix} ) ,$$

to perform the unitary transformation. In operation 204, Alice may send Bob the unitary-transformed quantum state, σₓ |ν [symbol] or σₛ |ν [symbol] (if a bit to be committed is ‘0’) or H|ν [symbol] or T|ν [symbol] (if a bit to be committed is ‘1’).

In the current example, by combining a random selection of the quantum state by the receiver (operation 100) with a unitary transformation selected by the sender (operation 200), the binding property and the concealing property may be ensured, thereby securing a reliable bit commitment protocol. In other words, by performing the bit commitment according to the current example, a secured quantum state equipped with the binding property and the concealing property may be sent from the sender to the receiver, as shown in the following Table 1.

TABLE 1

| Bit Commitment | |
|---|---|
| 0 | 1 |

| | | | | |
|---|---|---|---|---|
| Unitary Operation | σ [symbol] | σ [symbol] | H | I |

| | | | | | |
|---|---|---|---|---|---|
| Quantum | \|0 [symbol] | \|1 [symbol] | \|0 [symbol] | \|+ [symbol] | −\|− [symbol] |
| State | \|1 [symbol] | \|0 [symbol] | −\|1 [symbol] | \|− [symbol] | \|+ [symbol] |
| in Bob | \|+ [symbol] | \|+ [symbol] | \|− [symbol] | \|0 [symbol] | \|1 [symbol] |
| | \|− [symbol] | −\|− [symbol] | \|+ [symbol] | \|1 [symbol] | −\|0 [symbol] |

[symbol]

indicates data missing or illegible when filed

For the quantum state shown in Table 1, if Alice makes an EPR (Einstein-Podolsky-Rosen) attack to defeat the binding property, Alice may share |Φ [symbol] _{A B}=(U(ν)_{A} [symbol] V_{B})|Φ [symbol] _{A B} with Bob. In this case, Alice may not accurately control V_{B} without learning the quantum state, |ν [symbol] . On the other hand, if Bob prepares a quantum entanglement state, |ν [symbol] , to defeat the concealing property, Bob is given the same state for bit information of ‘0’ and of ‘1’, as expressed in the following equation 1. As a result, Bob may never learn the bit information.

(H [symbol] I)|Ψ [symbol] [symbol] Ψ|(H [symbol] I)+(T [symbol] I)|Ψ [symbol] [symbol] Ψ|(T [symbol] I)=(σ_{z} [symbol] I)|Ψ [symbol] [symbol] Ψ|(σ_{ν} [symbol] νI)+(σₓ [symbol] I)|Ψ [symbol] [symbol] Ψ|(σₓ [symbol] I) Equation 1

Referring back to FIG. 1, Alice and Bob performs a hold phase to maintain the committed bit information for a predetermined time period (operation 300). The time period is an interval between the commit phase (operation 200) and the reveal phase (operation 400). The time period may be a predetermined interval stipulated between Alice and Bob. In the current example, since the special theory of relativity is not employed to ensure the binding and concealing properties, there is no restriction on the holding period.

After the holding period, Alice performs the reveal phase to open the bit information to Bob (operation 400). The reveal phase (operation 400) is a process for validating the bit information (one which has been inserted through the unitary transformation), which has been committed by Alice in operation 200, for Bob. In the reveal phase (operation 400), Bob may perform a verification process to check if the bit information has been changed by Alice simultaneously with or in addition to the reveal phase. The verification process is a procedure for checking if the bit information matches the original quantum state selected in the pre-commit phase (operation 100). From the verification process, Bob may verify if the original commitment information has been changed by Alice, i.e., if the binding property has been kept.

More specifically, Alice provides Bob with information about the unitary transformation which has been randomly selected in operation 202 (operation 402). In the current example, since a type of the unitary transformation is determined depending on the committed bit, Bob may check the committed bit from the information about the unitary transformation. The information about the unitary transformation may be open to Bob through a classical channel rather than through an optical communication channel.

Bob may calculate the inverse unitary transformation of the quantum state, which has been unitary-transformed, using the information about the unitary transformation and perform a verification process to check if the calculation result (U⁻U|ψ [symbol] ) matches the original quantum state, |ν [symbol] , which has been selected in operation 102, i.e., the polarization of the photon (operation 404). To check if they match each other, an orthogonal measurement may be used which is determined according to a polarizing direction of the original quantum state, |ν [symbol] . For example, if the quantum state, |ν [symbol] , is |0 [symbol] or |1 [symbol] , a measurement is made with {|0 [symbol] [symbol] 0|, |1 [symbol] [symbol] 1|}; if |ν [symbol] is

$$\vert + 〉 = \frac{\vert 0 〉 + \vert 1 〉}{\sqrt{2}} \\ or \\ \vert - 〉 = \frac{\vert 0 〉 - \vert 1 〉}{\sqrt{2}} ,$$

a measurement is made with {|+ [symbol] [symbol] +|, |− [symbol] [symbol] −|}.

In the current example, the quantum states, |0 [symbol] , |1 [symbol] ,

$$\vert + 〉 = \frac{\vert 0 〉 + \vert 1 〉}{\sqrt{2}} \\ and \\ \vert - 〉 = \frac{\vert 0 〉 - \vert 1 〉}{\sqrt{2}} ,$$

which has been used in the pre-commit phase (operation 100), the unitary transformations,

$${σ}_{x} = ( \begin{matrix}0 & 1 \\ 1 & 0\end{matrix} ) , \\ {σ}_{z} = ( \begin{matrix}1 & 0 \\ 0 & - 1\end{matrix} ) , \\ H = \frac{{σ}_{x} + {σ}_{z}}{\sqrt{2}} = \frac{1}{\sqrt{2}} ( \begin{matrix}1 & 1 \\ 1 & - 1\end{matrix} )$$

$$and$$

$$T = \frac{{σ}_{x} - {σ}_{z}}{\sqrt{2}} = \frac{1}{\sqrt{2}} ( \begin{matrix}- 1 & 1 \\ 1 & 1\end{matrix} ) ,$$

which has been used in the commit phase (operation 200), and the orthogonal measurement, which has been used in the reveal phase (operation 400), are only examples for illustrative purposes. For example, by simultaneously performing a basis change with respect to the above-mentioned quantum states, unitary transformations and/or orthogonal measurement, the current example of the present invention may be implemented with a different type of quantum bit commitment protocol.

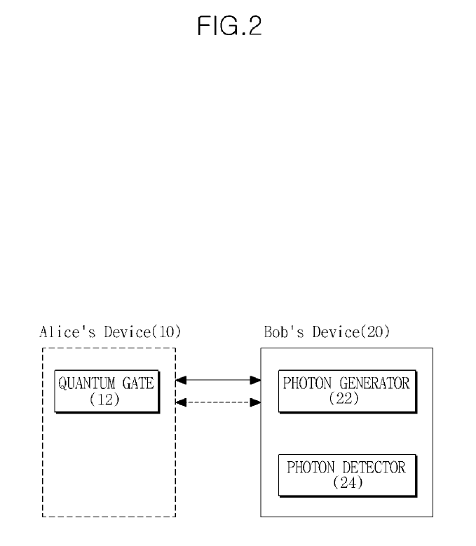

FIG. 2 is a block diagram illustrating an exemplary system for performing a quantum bit commitment protocol. FIG. 2 is an example of a system for performing the exemplary method in FIG. 1. The current example is not limited to the system in FIG. 2. Components of the system may be separated, or all of or some of them may be integrated into a single entity. Furthermore, Alice's device 10 and Bob's device 20 may be connected over a network so that they may communicate with each other through an optical communication channel as well as a classical communication channel.

Referring to FIG. 2, the exemplary system includes a photon generator 22, a quantum gate 12 and a photon detector 24. FIG. 2 illustrates a minimum number of quantum devices among components of the system according to the current example, which are necessary to understand the current example. Accordingly, it will be apparent to those skilled in the art that the exemplary system further includes general components, such as a transmitter and a receiver for transmitting and receiving photons, respectively, a controller, and a storage for storing the photons.

The system in FIG. 2 is configured to implement the method in FIG. 1 and will thus be simply described. The system will be understood better with reference to FIG. 1. Referring to FIG. 2, the photon generator 22 is configured to make a selection of a quantum state in operation 102 in FIG. 1. Information about the quantum state (i.e., generated photons) may be sent to Alice's device 10 through a fiber-optic cable or a free space. The quantum gate 12 is configured to perform a unitary transformation in operation 202 in FIG. 1. Information about the unitary-transformed quantum state (i.e., transformed photons) may be sent to Bob's device 20 through a fiber-optic cable or a free space. Bob holds the transformed photons in a predetermined storage for a predetermined time period (operation 300 in FIG. 1), and sends data (i.e., the unitary-transformed information) from Alice's device 10 to Bob's device 20. Since the data is not optical data, it may be sent through a classical communication channel. After acquiring the unitary transformation information, Bob's device 20 performs an inverse unitary transformation on the transformed photon. The photon detector 24 is configured to detect the inverse-transformed photon and determines if the detected information matches the photon generated by the photon generator 22.

As apparent from the above description, a protocol which does not fall within the presumption assumed in the MLC theorem is provided.

In addition, although the traditional relativistic quantum bit commitment protocol ensures an unconditional security and an asymptotic security in a two-way quantum communication, the exemplary non-relativistic quantum bit commitment protocol ensures an unconditional security in a two-way quantum communication.

Furthermore, the relativistic scheme employing the special theory of relativity has temporal and spatial restrictions and requires a great amount of communications, and needs a great deal of bait conditions to ensure a security in the existing protocol using a two-way quantum communication, a huge amount of resources are unavoidably consumed. On the contrary, the exemplary quantum bit commitment does not have to take into account the special theory of relativity and does not require bait conditions, thereby minimizing the use of resources. Accordingly, the exemplary quantum bit commitment can obtain as a high efficiency as the protocol which has been proved infeasible according to the MLC theorem.

Furthermore, the exemplary method and system for performing the quantum bit commitment is configured to be simple in structure and to efficiently use the resources. Accordingly, the exemplary method and system may contribute to extend the scope of the existing quantum bit commitment protocol which has been limited in uses due to its infeasibility and inefficiency.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of performing a quantum bit commitment protocol to send bit information from a first party to a second party, the method comprising:
a pre-commit phase to randomly select and send, by the second party, a quantum state to the first party;
a bit commit phase to perform, by the first party, a unitary transformation on the quantum state to combine the bit information with the quantum state and send the unitary-transformed quantum state to the second party;
a hold phase to hold the unitary-transformed quantum state for a predetermined time period; and
a reveal phase to provide, by the first party, information about the unitary transformation to the second party to open the bit information to the second party.

2. The method of claim 1, wherein the reveal phase comprises a verification process to check if the opened bit information matches the bit information committed in the bit commit phase.

3. The method of claim 2, wherein the verification process comprises checking if a quantum state obtained by performing an inverse unitary transformation of the unitary-transformed quantum state matches the quantum state selected in the pre-commit phase.

4. The method of claim 3, wherein the checking uses an orthogonal measurement which is determined depending on the quantum state selected in the pre-commit phase.

5. The method of claim 1, wherein the pre-commit phase randomly uses arbitrary non-orthogonal quantum states including |0 [symbol] , |1 [symbol] ,
$$\vert + 〉 = \frac{\vert 0 〉 + \vert 1 〉}{\sqrt{2}} , \\ and \\ \vert - 〉 = \frac{\vert 0 〉 - \vert 1 〉}{\sqrt{2}} .$$

6. The method of claim 1, wherein the bit commit phase comprises selecting one of sets of unitary transformations, {σₓ, σ_{z}} and {H, T}, depending on the bit information to be committed, and randomly using one of unitary transformations belonging to the selected unitary transformation set.

7. The method of claim 1, wherein basis changes are simultaneously performed with respect to the quantum state of the pre-commit phase, the unitary transformation of the commit phase, and the orthogonal measurement of the reveal phase.

8. A system for performing the method of claim 1.

9. A method of performing a quantum bit commitment protocol, comprising:
randomly selecting, by a first party, a quantum state and sending the quantum state to a second party; and
performing, by the second party, a unitary transformation on the received quantum state based on the bit information to be committed and sending the unitary-transformed quantum state to the first party.

10. The method of claim 9, wherein the first party randomly uses arbitrary non-orthogonal quantum states including |0 [symbol] , |1 [symbol] ,
$$\vert + 〉 = \frac{\vert 0 〉 + \vert 1 〉}{\sqrt{2}} , \\ and \\ \vert - 〉 = \frac{\vert 0 〉 - \vert 1 〉}{\sqrt{2}} .$$

11. The method of claim 9, wherein the second party selects one of sets of unitary transformations, {σₓ, σ_{z}} and {H, T}, depending on the quantum bit, and randomly using one of unitary transformations belonging to the selected unitary transformation set.

12. The method of claim 9, wherein the first party holds the unitary-transformed quantum state for a predetermined time period, and the second party reveals information about the quantum bit to the first party.

13. The method of claim 9, wherein revealing the information about the quantum bit comprises a verification process to send, by the second party, information about the unitary transformation to the first party and verify, by the first party, a binding property on the quantum bit using the information about the unitary transformation.

14. The method of claim 13, wherein the verification process comprises performing an inverse unitary transformation of the unitary-transformed quantum state and determining if a quantum state obtained by performing the inverse unitary transformation of the unitary-transformed quantum state matches the quantum state selected by the first party.

15. The method of claim 14, wherein the determining uses an orthogonal measurement which is determined depending on the quantum state selected by the first party.

16. The method of claim 15, wherein if the quantum state selected by the first party is |0 [symbol] or |1 [symbol] , a measurement is made with {|0 [symbol] [symbol] 0|, |1 [symbol] [symbol] 1|}, and if the quantum state is
$$\vert + 〉 = \frac{\vert 0 〉 + \vert 1 〉}{\sqrt{2}} \\ or \\ \vert - 〉 = \frac{\vert 0 〉 - \vert 1 〉}{\sqrt{2}} ,$$
a measurement is made with {|+ [symbol] [symbol] +|, |− [symbol] [symbol] −|}.
